(19) United States
(12) Patent Application Publication
(10) Pub. No.: US 2014/0076597 A1
(43) Pub. Date: Mar. 20, 2014

(54) Subterranean Cable

(71) Applicant: BPP Cables Ltd., London (GB)

(72) Inventor: Darren Lindsay Patel, Essex (GB)

(21) Appl. No.: 14/030,263

(22) Filed: Sep. 18, 2013

(30) Foreign Application Priority Data
Sep. 18, 2012 (GB) 1216685.6
Dec. 20, 2012 (GB) 1223227.8

(51) Int. Cl. H02G 9/02; H01B 13/016

(52) U.S. Cl. CPC H02G 9/02; H01B 13/016
USPC 174/37; 29/828

(57) ABSTRACT

The present invention relates to a cable comprising a first conductor and a first insulator layer, wherein the first conductor and the first insulator extend along a longitudinal axis of the cable, wherein the first insulator layer is axially external to the conductor, and wherein the first insulator layer comprises a first fluoropolymer, as well as a method of manufacturing said cable, and a method for transmitting electricity using the cable.

### CROSS-REFERENCE TO RELATED APPLICATIONS

This application claims priority to United Kingdom Patent Application Nos. GB1216685.6 filed on Sep. 18, 2012 and GB1223227.8 filed on Dec. 20, 2012, which applications are incorporated by reference herein in their entirety.

### FIELD OF INVENTION

The present invention relates to a cable for conducting electricity and carrying tension, and is particularly useful for subterranean applications. The invention also relates to an insulation layer to electrically insulate the conductor component of such cables.

### BACKGROUND

Devices are routinely placed in wellbores during the course of oil exploration or production. Such devices are often powered by electricity, which is transmitted by power cables from the surface. Devices include monitoring devices (to provide information regarding the subterranean formations surrounding the wellbore) and pumps (to aid in pumping oil to the surface).

The downhole environment and the power requirements of the devices present a number of challenges when providing such cables. For instance, the downhole environment may be corrosive (for instance, the environment may exhibit extremes of pH's, or may be oxidative or reductive, for instance, if hydrogen sulphide is present), and thus cables need to be resistant to such challenges. Downhole temperatures can vary with depth; typically temperatures increases with increasing depth, meaning the components of the cable must function properly in a wide range of temperatures. If the power cable is also used to suspend, or lower and lift devices into and out of the wellbore, the power cable must be strong enough to support the devices. Not only must such cables be strong enough to support the devices, an important consideration is that they must be strong enough to support their own weight: where the depth of wellbore is several hundreds, if not thousands of meters long, the self-weight of the cable itself may be substantial. The cable must also be mechanically robust and resilient so that an operator can use it in the field repeatedly without concern that it will fail. Most importantly, the cable must be capable of providing sufficient electrical power to any device downhole. Finally, wellbore environments are typically restricted in terms of space, which in turn places restrictions on the maximum allowable cable diameter. A typical wellbore may have an inner diameter as small as around 5 inches, and the maximum diameters of cables are typically restricted to a fraction of the wellbore diameter. These requirements, taken together, present challenges when providing cables suitable for use downhole.

### SUMMARY OF THE INVENTION

In a first aspect, the present invention provides a cable comprising a first conductor, a first insulator layer and a first plurality of wires, wherein the first conductor, the first insulator and the first plurality of wires extend along an longitudinal axis of the cable, wherein the first insulator layer is axially external to the conductor, and the first plurality of wires is axially external to the first insulator, and wherein the first insulator layer comprises a first fluoropolymer.

In a second aspect the present invention provides use of a fluoropolymer as an insulator in an armoured cable for use downhole.

In a third aspect the present invention provides a method of manufacturing a cable of the invention, comprising disposing the first insulator layer around the first conductor and along a longitudinal axis thereof, and disposing the first plurality of wires around the first insulator layer and along a longitudinal axis thereof, wherein the first insulator layer comprises the first fluoropolymer.

In a fourth aspect the present invention provides a method of transmitting electricity, comprising connecting a first installation or device with a second installation or device with a cable according to the present invention, and transmitting electricity from the first installation or device to the second installation or device through the cable, wherein the first installation or device is in a wellbore.

In a fifth aspect, the present invention provides a method of suspending a first device or installation in a wellbore, comprising providing a cable of the invention, securing a first end of the cable to the first device or installation, securing a second end of the cable to a second device or installation, and suspending the first device or installation in the wellbore.

Further features are defined in the dependent claims.

### BRIEF DESCRIPTION OF THE DRAWING

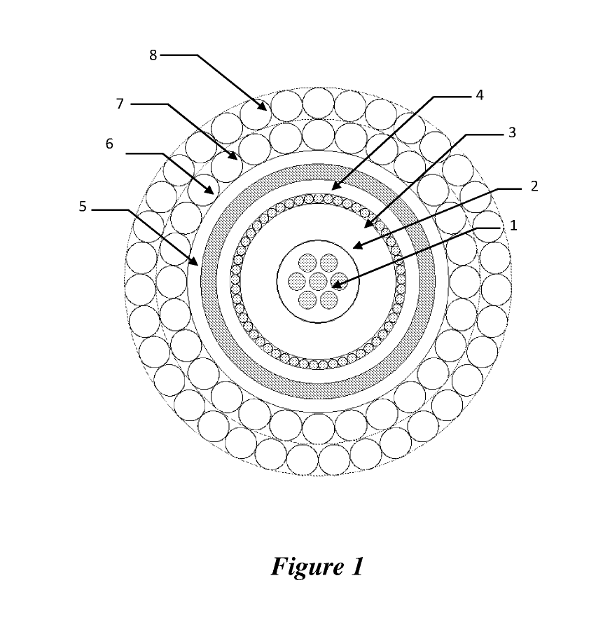

The accompanying FIG. 1 helps illustrate the example and the present invention, but is not to be construed as limiting the invention. FIG. 1 shows a cross section of an embodiment of the cable of the present invention, and is not to scale. The first conductor 1 forms the central core of the cable. The cable may be formed of a plurality of wires (7 are schematically shown, although more may be used). The first conductor is surrounded by a first insulator layer 2. The first insulator layer is surrounded by a second conductor 3. The second conductor may be formed of a plurality of wires disposed around the first insulator layer to form, in effect, a layer of conductor. The second conductor is surrounded by a second insulator layer 4. The second insulator layer is surrounded by a barrier layer 5, which is surrounded by a jacket layer 6. Armour wires are provided on the outside of the cable—a first plurality 7 is disposed in a layer, which is surrounded by a second plurality of wires 8.

### DETAILED DESCRIPTION

The present invention relates to a cable for conducting electricity, in particular, for cables used in subterranean applications. The invention also relates to an insulation layer to insulate the conductor component of such cables. The cables of the present invention are particularly useful for providing DC (direct current) electricity to downhole devices, but may equally be used for convey AC (alternative current) electricity.

The cable may be used to power any downhole device that uses electricity, and is particularly useful for powering ESP's (electrical submersible pumps). The present invention is particularly useful when configured as a DC cable for powering ESP's, since it is believed that no DC ESP cables are currently thought to be available. The cable of the present invention is capable of operating at around 5 kV to 6 kV, with a current carrying capacity of 100 A. The cable can also be subjected to relatively high temperatures. For instance, the cable may be used in downhole temperatures of up to 80° C., up to 90° C., up to 100° C., up to 120° C., up to 130° C., up to 140° C., or up to 150° C. Further, the cable may be used in corrosive environments, for instance, in low or high pH's, or in oxidative or reductive environments. For instance, the cable is able to tolerate exposure to hydrogen sulphide of around 4%-6% (mol). The cable may also be subjected to working loads of at least 10,000 lbs (44.5 kN). In a particularly preferred embodiment, present invention provides a DC cable for powering an ESP.

The cable of the present invention comprises a first conductor, a first insulator layer and a first plurality of wires, wherein the first conductor, the first insulator and the first plurality of wires extend along an longitudinal axis of the cable, wherein the first insulator layer is axially external to the conductor, and the first plurality of wires is axially external to the first insulator, and wherein the first insulator layer comprises a first fluoropolymer.

International standard IEC 60287 (set out by the International Electrotechnical Commission) provides ampacity calculations for the sizes of the central and return conductors for medium-voltage and high voltage power cables of various construction types. The first conductor of the present invention is sized to allow for sustained and safe level of current which does not lead to overheating of the cable, so that the maximum allowable operating temperature is not exceeded. Overheating can lead to a number of problems, such as premature degradation and break down of the insulation layers. Other factors which determine conductor sizing include the operating environment, expected number of flex cycles during operation, mechanical capacity, the cable type and its service conditions.

When the conductor is energized, heat is generated within the cable due to the electrical losses of the conductor, the dielectric losses in the insulation and the losses in the metallic elements of the cable. The size and ampacity of the cable is dependent on the way the heat is transmitted to the cable surface and ultimately dissipated to the surrounding environment. The rate of heat dissipation is dependent on the various thermal resistances of the cable materials and on the external medium and ambient temperature. If the cable is able to dissipate more heat, the conductors can be smaller for a given current carrying capacity.

The normal maximum continuous rating of the cable is dependent on a number of factors. The most important of these is the maximum permissible conductor temperature rise (above ambient temperature). The maximum current rating is the loading (in amperes) which, when applied continuously until steady state conditions are reached, will produce the maximum allowable conductor temperature. Steady state is reached when the rate of heat generation in the cable is equal to the rate of heat dissipation from the cable's surface. This state is the primary condition considered when calculating current rating. The resistance of the first conductor should be as low as possible to minimize power losses from the conductors.

In an embodiment, the first conductor and/or the second comprises copper or copper alloy. Copper has many excellent properties that make is a suitable material for a conductor, such as excellent conductivity and mechanical strength, and thus is the most preferred material for use as the first or second conductor. Different grades of copper may be used if desired (e.g. UNS C11000 or C10300—note “UNS” stand for “unified numbering system”). Copper alloys such as copper beryllium alloys (e.g. UNS C17000), copper brass alloys (e.g. UNS C26000), copper nickel alloys (e.g. UNS C71500 or C71640), copper aluminium brasses (e.g. UNS C68800) may also be used for the first or second conductors. Such alloys may provide slightly improved mechanical characteristics (such as higher tensile and fatigue strengths), but may do so at the expense of slightly lower thermal and electrical conductivities, or increased cost (This is accurate and correct to say). The skilled person will appreciate whether copper or a copper alloy should be used in the cable of the present invention.

The first and/or second conductor may be formed of a single strand (also known as a solid core), or a plurality of stranded wires. The plurality of stranded wires is preferred, due to its improved flexibility and improved resistance to fatigue compared to solid core configurations. The plurality of wires may also be braided, since braids may further improve the resistance of the conductor to fatigue. In particular, the braid configuration provides good electrical and mechanical performance, at the same time exhibiting good resistance forces generated from repeated pulling and relaxing of the cable that can occur during operation.

The first insulation layer of the present invention comprises a fluoropolymer. In an embodiment, the first insulation layer may also consist of the fluoropolymer—that is to say, in this embodiment, the first layer may be formed of entirely from the first fluoropolymer. The first insulation layer serves to insulate and electrically isolate the first conductor from other components of the cable, such as the second conductor. The insulation thickness should be sufficient to sustain the electrical stresses developed during cable operation.

Electrical field distribution depends on the specific conductivity of the insulation, which itself is highly dependent on the temperature and electric field. The highest electrical stress develops in the insulation region closest to the conductor, as the electric field drives the stress distribution while the cable carries no load. As the cable is subjected to full load, a temperature gradient develops, and this affects the electrical stress much more than the electrical field previously did. As a result of a temperature rise near the conductor, the electrical stress exhibits a tendency for an increase at the outer radius of the insulation and a decrease in the insulation region closer to the conductor.

The fluoropolymers of the present invention will now be described. It will be appreciated that any description of fluoropolymer provided herein applies equally to the second, third and fourth fluoropolymers as well as the first fluoropolymer.

Fluoropolymers are polymers based on fluorocarbons, which comprise strong carbon-fluorine bonds. Such polymers exhibit high resistance to solvents, acids and bases, as well as a good resistance to high temperatures. Some fluoropolymers are known for their non-stick and friction-reducing properties. The best known example of a fluoropolymer is polytetrafluoroethylene, commercially available as Teflon™, which is commonly used as a non-stick coating for cookware. As used herein, the term “fluoropolymer” means any molecule comprising at least one repeating structural unit, where the at least one structural unit comprises at least one carbon-fluorine bond. Each structural unit is preferably covalently bonded to another structural unit. A typical fluoropolymer comprises a backbone of repeating —(CR₁R₂—CR₃CR₄)— structural units, where at least one of R₁ to R₄ is a fluorine atom. Provided at least one of R₁ to R₄ is a fluorine atom, possible moieties for the other R₁ to R₄ (i.e. the ones that are not fluorine) may be individually selected from —H, —CH₃, —CF₃, —Cl, —CCl₃, —OCH₃, —OCF₃, —OCF₂CF₃, —OCF₂CF₂CF₃, and —OCF₂CF₂ CF₂CF₃. Each of the repeating structural units can be identical, Alternatively, there can be two, three or more distinct structural units; where there are two or more structural units, the resulting polymer is typically called a copolymer.

The molecular sizes of the fluoropolymers of the present invention may vary, but are sufficiently large such that they are solid at the temperatures at which the cables of the present invention operate. The minimum melting temperatures of any fluoropolymer for use with the invention may be 225° C., 230° C., 235° C., 240° C., 245° C., 250° C., 255° C., or higher.

In an embodiment, the fluoropolymer is a polymer consisting of one monomer. In another embodiment the fluoropolymer is a copolymer comprising two different monomers. In another embodiment, the fluoropolymers may comprise three, four or more different monomers.

The first insulator layer of the cable comprises a first fluoropolymer. In another embodiment, the first insulator layer of the cable consists of a first fluoropolymer. The first fluoropolymer may comprise, or consist of, a first monomer. The first monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The first fluoropolymer may further comprise a second monomer. In another embodiment, the first fluoropolymer may consist of a first and a second fluoropolymer. The second monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

In a preferred embodiment, the first fluoropolymer consists of two alternating monomers of ethylene and 1,1,2,2-tetrafluoroethylene, given by the structure (—CH₂—CH₂—CF₂—CF₂—)ₙ. The fluoropolymer is also known as ETFE, or poly(ethylene-co-tetrafluoroethylene). This fluoropolymer is commercially available under the brand names Tefzel™, Fluon™, Neoflon™ and Texlon™. ETFE exhibits a number of desirable properties, including a high melting temperature and high chemical resistance. In another preferred embodiment, the first fluoropolymer consists of one monomer of 1,1,2,2-tetrafluoroethylene. The structure of this polymer is (—CF₂—CF₂—)ₙ, and is known as poly(1,1,2,2-tetrafluoroethylene), or PTFE.

The use of a fluoropolymer in the first insulation layer (or in the second insulation layer) is unusual. This is because such materials are not typically used as insulators, since there are other insulator materials which are normally used. Usually synthetic rubber based materials such as PVC (polyvinyl chloride) or EPDM (ethylene propylene diene monomer) are used, since they provide acceptable insulation capabilities in most circumstances, but at a much reduced cost compared to fluoropolymers. However the surprising discovery has been made that fluoropolymers (in particular, PTFE and ETFE) provide better electrical insulation at a broader temperature range (in particular, at elevated temperatures). Further, fluoropolymers (especially ETFE and PTFE) exhibit an improved decomposition temperature, durability and chemical resistance compared to known insulators, which in turn allows for a higher conductor temperature, which in turn allows for a greater steady state current. The higher resistance to thermal and chemical degradation also contributes to a reduced degradation of the insulating layer, thereby leading to an improved longevity of the cable itself. This higher resistance is also thought to allow the cable of the present invention, when used as an ESP cable, to be deployed downhole for relatively long periods compared to existing ESP cables.

Since the electrical insulating capabilities of the insulating layers are improved at higher temperatures, the present invention in turn allows for a thinner insulation layer than previously possible. Further, fluoropolymer insulation provides higher hoop (circumferential) strength to the cable core than rubber insulation. This allows for a thinner insulation layer and in some cases removal of braided reinforcement which in turn allows for an improved capability of the cable to dissipate heat from the first conductor in the core of the cable, as well as allowing for a thicker central core conductor for a given diameter of cable (i.e. since the maximum diameter of the cable is limited due to the constraints imposed by the limited space of the wellbore, if a lower proportion of the diameter is taken up by the insulator, then other components such as the conductor can occupy a greater proportion of the diameter). The combination of a thinner insulation layer and a thicker conductor core together provides an improvement in the ampacity of the cable.

In addition, fluoropolymers exhibit other desirable characteristics making them suited for use as insulation for downhole cables. This includes low dielectric loss; good resistance to stress cracking; good resistance to chemicals; excellent mechanical properties, such as high tensile strength, ‘cut-through’ resistance, and low creep. Fluoropolymers exhibit an ideal level of stiffness that means it is not too stiff, such that the cable has enough flexibility for use, but not too flexible and soft, such that the insulation material does not extrude through the armour wires when the cable is under tension. Furthermore, fluoropolymers retain these properties at the higher temperatures, which means these advantages are seen across the range of temperatures seen downhole. ETFE is a particularly advantageous fluoropolymer for use with the invention in this regard.

The fluoropolymers used with the invention may be foamed or non-foamed. Foaming the fluoropolymers may reduce costs by reducing the amount of material used. However, the fluoropolymers used with the invention are preferably non-foamed, since the advantages listed above may be reduced to some extent when the fluoropolymer is foamed.

Note the cables of the present invention may need to be deployed in wellbores with diameter as low as 4.9 inches (12.5 cm), or even smaller, meaning the cables need to be as small as possible.

The cable may further comprise a second conductor, wherein the second conductor extends along the longitudinal axis of the cable and is axially external to the first insulator. This second conductor preferably serves as a return conductor. The return conductor may provide a low DC resistance path for the electrical current running through the central conductor (if the cable is used to conduct DC current). The return current may flow through the second conductor at a lower voltage. The return conductor may also carry any fault current loads. In a preferred embodiment, the second conductor comprises a plurality of wires. This plurality of wires may be arranged to provide a layer surrounding the first insulator layer. In a preferred embodiment, the plurality of wires is braided.

In an embodiment, the cable further comprises a second insulator layer comprising a second fluoropolymer wherein the second insulator layer extends along the longitudinal axis of the cable and is axially external to the second conductor. The second insulator layer serves to insulate the second conductor from the other components of the cable axially external to the second conductor, such as the external armour or the surrounding environment.

The second insulator layer of the cable comprises a second fluoropolymer. In another embodiment, the second insulator layer of the cable consists of a second fluoropolymer. The second fluoropolymer may comprise, or consist of, a third monomer. The third monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The second fluoropolymer may further comprise a fourth monomer. In another embodiment, the second fluoropolymer may consist of a third and a fourth fluoropolymer. The fourth monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. In a preferred embodiment, the second fluoropolymer consists of two alternating monomers of ethylene and 1,1,2,2-tetrafluoroethylene or most preferably, the second fluoropolymer consists of one monomer of 1,1,2,2-tetrafluoroethylene, i.e. PTFE.

The cable may further comprise a barrier layer comprising a third fluoropolymer, wherein the barrier layer extends along the longitudinal axis of the cable and is axially external to the first and second insulator layer. The barrier layer provides a number of roles, including providing further insulation of the internal components of the cable from the external environment or any current in the armour, but also provides an impermeable layer to prevent ingress of any gas and liquid into the interior of the cable, and to protect the internal conductors and insulator layers from corrosive substances found in the wellbore, such as hydrogen sulphide.

The barrier layer of the cable comprises a third fluoropolymer. In another embodiment, the barrier layer of the cable consists of a third fluoropolymer. The third fluoropolymer may comprise, or consist of, a fifth monomer. The fifth monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The third fluoropolymer may further comprise a sixth monomer. In another embodiment, the third fluoropolymer may consist of a fifth and a sixth monomer. The sixth monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. In a preferred embodiment, the third fluoropolymer consists of one monomer of 1,1,2,2-tetrafluoroethylene, i.e. PTFE, or most preferably, the third fluoropolymer consists of two alternating monomers of ethylene and 1,1,2,2-tetrafluoroethylene, i.e. ETFE

In an embodiment, the cable further comprises a jacket layer comprising a fourth fluoropolymer, wherein the jacket layer extends along the longitudinal axis of the cable and is axially external to the second insulator layer, or external to the barrier layer, if present. The jacket layer serves as a further protective layer for the internal components of the cable. The primary role of the jacket layer is to provide mechanical protection of the internal conductors, insulator layers and barrier layer from the environment and the armour wires. In particular, when the cable comprises an external layer of armour wires (see below), such armour wires can deform under load, and return to their original geometry during unloading. This deformation of the armour wires subjects the internal components of the cable to considerable mechanical stress. The jacket provides protection of the internal components from such mechanical stresses.

The jacket layer of the cable comprises a fourth fluoropolymer. In another embodiment, the jacket layer of the cable consists of a fourth fluoropolymer. The fourth fluoropolymer may comprise, or consist of, a seventh monomer. The seventh monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

The fourth fluoropolymer may further comprise an eighth monomer. In another embodiment, the fourth fluoropolymer may consist of a seventh and a eighth fluoropolymer. The fourth monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. In a preferred embodiment, the fourth fluoropolymer consists of two alternating monomers of ethylene and 1,1,2,2-tetrafluoroethylene or most preferably, the fourth fluoropolymer consists of one monomer of 1,1,2,2-tetrafluoroethylene, i.e. PTFE.

As described previously, the first, second, third and fourth fluoropolymers may consist of, or comprise, one or two monomers. However the first, second, third and fourth fluoropolymers may alternatively further comprise three, four of more monomers. These further monomers may be selected from the list of monomers described above.

As noted above, in a preferred embodiment, the first insulation layer, second insulation layer, barrier layer and jacket layer each comprise of or consist of PTFE, PTFE, ETFE and PTFE, respectively. However, it will be appreciated that other combinations of fluoropolymers are envisaged. For instance, all four fluoropolymers may be the same, e.g. all consisting of, or comprising, ETFE or PTFE. Alternatively, all fluoropolymers may be different.

The first insulator layer, second insulator layer, barrier and jacket layer may each be formed by extrusion, thereby providing a contiguous and seam-free layer. Alternatively, they made by formed by wrapping or winding tape around the cable. If tapes of material are used, then it is important that tapes are wrapped/wound in a manner to create a continuous layer. Since extrusion is more likely to provide contiguous/seam-free layers, extrusion is referred.

The cable further comprises a first plurality of wires, wherein the first plurality of wires extends along the longitudinal axis of the cable and is axially external to the first insulator layer. If the cable further comprises any one or more of a second conductor, second insulator, barrier layer and/or jacket layer, then the first plurality of wires may be disposed axially externally to these features. These armour wires fulfil a number of roles. They provide tensile strength to the cable, such that it can both support its own weight, and that of any devices suspended using the cable during operation in a wellbore. This means that the cable of present invention can support other commonly used downhole devices, such as pumps, sensors and motors, in addition to its own self-weight. This is particularly useful when the cable of the present invention is used for powering an ESP, since not only can it support its own weight, it can support other equipment typically used during the operation of an ESP, such as the pump, motor and inverter. This is in contrast with presently available ESP cables, which lack tensile capacity and thus do not bear any weight themselves. This means presently available ESP cables are typically strapped to other cables/wires which are run into the hole in parallel with the ESP cables to specifically provide the load-bearing function. The armour wires also provide the cable with integrity, in particular, by preventing the cable from flattening (and thus squashing the internal components), as well as preventing twisting, stretching and over-flexion of the cable. The cable may further comprise a second plurality of wires, wherein the second plurality of wires also extends along the longitudinal axis of the cable and is axially external to the first plurality of wires. Preferably, the wires of the first plurality of wires are helically wound in a first direction, and the wires of the second plurality of wires are helically wound in a direction opposition to the first. Providing two sets of wires provides a greater level of protection and load-carrying capacity compared to having just one set of wires. Winding of the two sets of wires in this manner provides the armour wires with further resistance against torsional, flexural and stretching forces.

Armour wires can be made of a resilient metal such as steel or steel alloy. However, given the armour may be subjected to harsh and corrosive environments, other materials with improved resistance to corrosion may be used instead, such as galvanised steel, stainless steel, or high strength stainless steel. For instance, the armour wires may be made of GIPS (galvanised improved plow steel) wires. However, GIPS is prone to cracking in H₂S-rich environments, which may lead to wire failure. Stainless steel, for instance, may be more resistant to hydrogen sulphide than galvanised steel.

In a particularly preferred embodiment, the armour wires comprise of, or consist of, a nickel-based alloy, which may provide the wires with a high resistance to cracking from exposure to hydrogen sulphide. Suitable nickel-based alloys comprise of, or consist of, nickel and chromium and optionally up to 20% (w/w) additives or impurities. The additives or impurities include, but are not limited to, iron, molybdenum, niobium, cobalt, manganese, copper, aluminium, titanium, silicon, carbon, sulphur, phosphorus or boron, or any combination thereof. The nickel-based alloy may comprise of, or consist of, from 40 to 74% (w/w) nickel, 14 to 25% (w/w) chromium, and optionally up to 20% (w/w) additives or impurities.

The nickel based alloy may comprise, or consist of, 72% (w/w) nickel, 14-17% (w/w) chromium, 6-10% (w/w) iron, 1% (w/w) manganese, 0.5% (w/w) copper, with remainder impurities or additives (this alloy is available commercially under the name Inconel 600™).

The nickel based alloy may comprise, or consists of, 44.2%-56% (w/w) nickel, 20-24% (w/w) chromium, 3% (w/w) iron, 8-10% (w/w) molybdenum, 10-15% (w/w) cobalt, 0.5% (w/w) manganese, 0.5% (w/w) copper, 0.8-1.5% (w/w) aluminium, 0.6% (w/w) titanium with remainder impurities or additives (this alloy is available commercially under the name Inconel 617™).

The nickel based alloy may comprise, or consists of 58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives (this alloy is available commercially under the name Inconel 625™). This is the most preferred nickel-based alloy for use with the invention.

The nickel based alloy may comprise, or consists of 50-55% (w/w) nickel, 17-21% (w/w) chromium, 2.8-3.3% (w/w) molybdenum, 4.75-5.5% (w/w) niobium, 1% cobalt, 0.35% (w/w) manganese, 0.2-0.8% (w/w) aluminium, 0.65-1.15% (w/w) titanium, 0.3% (w/w) copper with remainder impurities or additives (this alloy is available commercially under the name Inconel 718™).

The nickel based alloy may comprise, or consists of 70% (w/w) nickel, 14-17% (w/w) chromium, 5-9% (w/w) iron, 0.7-1.2% (w/w) niobium, 1% (w/w) cobalt, 1% (w/w) manganese, 0.5% (w/w) copper, 0.4-1% (w/w) aluminium, 2.25-2.75% (w/w) titanium with remainder impurities or additives (this alloy is available commercially under the name Inconel X-750™).

The diameter of the cable, and the thickness of the various layers, may be varied. In a preferred embodiment, the cross-sectional area of the first conductor is in the range of from 15 to 25 mm², more preferably from 18 to 22 mm², most preferably 21.1 mm². The first insulator layer may have a thickness of from 1.8 to 3.0 mm, preferably from 2.1 mm to 2.7 mm, most preferably 2.4 mm. The second conductor may have a cross-sectional area in the range of from 20 mm² to 32 mm², more preferably from 23 mm² to 29 mm², most preferably 25.8 mm². The second insulator may have a thickness in the range of from 0.6 to 1.3 mm, more preferably 0.8 to 1.1 mm, most preferably 0.95 mm. The barrier layer may have a thickness in the range of from 0.3 to 0.7 mm, more preferably 0.4 to 0.6 mm, most preferably 0.5 mm. The jacket layer may have a thickness in the range of from 0.7 to 1.3 mm, more preferably 0.8 to 1.2 mm, most preferably 1.0 mm. The layer formed of the first plurality of wires may have a thickness in the range of from 0.8 to 1.6 mm, preferably in the range of 1.0 to 1.4 mm, most preferably 1.2 mm. The layer formed of the second plurality of wires may have a thickness in the range of from 0.8 to 1.6 mm, preferably in the range of 1.0 to 1.4 mm, most preferably 1.1 mm.

In another aspect, the present invention provides a use of a fluoropolymer as an insulator in a cable. In an embodiment, the cable is subjected to temperatures greater than 80° C., 90° C., 100° C., 110° C., 120° C., 130° C., 140° C., or 150° C.

The fluoropolymer may comprise, or consist of, a first monomer. The first monomer may be selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene. Alternatively, the fluoropolymer may further comprise a second monomer, or the fluoropolymer may consist of a first and second monomer. The second monomer may be selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene. Particularly preferred fluoropolymers for use as an insulator are PTFE or ETFE.

In another aspect, the present invention provides a method of manufacturing a cable of the invention, comprising: disposing the first insulator layer around the first conductor and along a longitudinal axis thereof, and disposing the first plurality of wires around the first insulator layer and along a longitudinal axis thereof, wherein the first insulator layer comprises the first fluoropolymer. The method may further comprise providing the second conductor, and disposing the second conductor along the longitudinal axis and external to the first insulator layer.

The first conductor may comprise copper or copper alloy. The second conductor may comprise copper or copper alloy. The first conductor may comprise a plurality of stranded wires. The second conductor may comprise a plurality of stranded wires. The plurality of the stranded wires of the first conductor may be braided. The plurality of the stranded wires of the second conductor may be braided.

A second insulator layer may be provided, which may be disposed along the longitudinal axis and around the second conductor. A barrier layer may also be provided, which barrier layer may be disposed around the barrier layer around the first and second insulating layers. A jacket layer may also be provided, which may be disposed around the barrier layer.

The method may further comprise the steps of providing a first plurality of wires, and disposing the first plurality of wires along the longitudinal axis of the cable and axially external to the jacket layer. The external surface of the jacket layer is preferably surrounded by the first plurality of wires. A second plurality of wires may be provided, which may then be disposed extending along the longitudinal axis of the cable and axially external to the first plurality of wires. The first plurality of wires may be helically wound in a first direction, and the wires of the second plurality of wires may be helically wound in a direction opposition to the first.

In another aspect the present invention provides a method of transmitting electricity, comprising providing a first installation or device and a second installation or device connected by a cable according to the present invention, and transmitting electricity from the first installation or device to the second installation or device through the cable, wherein the first installation or device is in a wellbore.

The first installation or device may be a sensor or an electrical submersible pump, or any other device typically used downhole for oil exploration or production that also requires electricity. The second installation or device may be a reel or spool, which may be installed at the surface.

The first device may be lowered into the wellbore by lowering a tension applied to the cable, i.e. by relaxing tension on the cable, the device or installation may lower into the wellbore under the influence of gravity. After the first device or installation has fulfilled its role or function downhole, it may be raised from the wellbore by increasing a tension to the cable. In other words, by pulling on the cable from the surface, the device or installation and the cable may be pulled out of the hole. The reel or spool installed on the surface may be used to lift or lower the device/installation from the surface, as well as storing any excess cable. Alternatively, a separate device, such as a hoist or winch may be used to lift/lower the first installation or device, and in this case, the reel or spool may be used to only store the excess cable.

### Example

The invention may be better understood with reference to the following example.

A cable was formed with the following characteristics:

First conductor: compact 37 wire, copper (21.1 mm²)
First insulator layer: PTFE (2.4 mm)
Second conductor: copper (25.8 mm²)
Second insulator layer: PTFE (0.95 mm)
Barrier layer: ETFE (0.5 mm)
Jacket layer: PTFE (1.0 mm)
Layer of first plurality of armour wire: stainless steel (1.2 mm)
Layer of second plurality of armour wire: stainless steel (1.1 mm)

This provides a cable having the following properties:
Outer diameter of 21.1 mm
Voltage rating (conductor-return) 5 kV DC
Voltage rating (return-armour) 2.5 kV DC
DC resistance—first conductor 0.9 ohms/km
DC resistance—second conductor 0.7 ohms/km
Current rating 120 A
Weight: 1.41 kg/m
Working load 44.5 kN
Minimum breaking tension 133.6 kN
Minimum bending radii (zero tension) 0.36 m; (33.7 kN operating tension) 0.43 m

### ADDITIONAL EMBODIMENTS

In addition to the claimed embodiments in the appended claims, the following is a list of additional embodiments which may serve as the basis for additional embodiments in this application or in subsequent divisional applications:

### Embodiment 1

A cable comprising a first conductor, a first insulator layer and a first plurality of wires, wherein the first conductor, the first insulator and the first plurality of wires extend along an longitudinal axis of the cable, wherein the first insulator layer is axially external to the conductor and the first plurality of wires is axially external to the first insulator, and wherein the first insulator layer comprises a first fluoropolymer.

### Embodiment 2

A cable according to embodiment 1, wherein the first fluoropolymer is a copolymer comprising a first monomer and a second monomer.

### Embodiment 3

A cable according to embodiment 2, wherein the first monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

### Embodiment 4

A cable according to embodiment 2, wherein the first monomer is 1,1,2,2-tetrafluoroethylene.

### Embodiment 5

A cable according to embodiment 2, wherein the first monomer is 1-fluoroethylene.

### Embodiment 6

A cable according to embodiment 2, wherein the first monomer is 1,1-difluoroethylene.

### Embodiment 7

A cable according to embodiment 2, wherein the first monomer is 1,2-difluoroethylene.

### Embodiment 8

A cable according to embodiment 2, wherein the first monomer is 1,1,2-trifluoroethylene.

### Embodiment 9

A cable according to embodiment 2, wherein the first monomer is hexafluoropropene.

### Embodiment 10

A cable according to embodiment 2, wherein the first monomer is perfluoropropyl vinyl ether.

### Embodiment 11

A cable according to embodiment 2, wherein the first monomer is perfluoroethyl vinyl ether.

### Embodiment 12

A cable according to embodiment 2, wherein the first monomer is perfluoromethyl vinyl ether.

### Embodiment 13

A cable according to embodiment 2, wherein the first monomer is perfluorobutyl ether.

### Embodiment 14

A cable according to embodiment 2, wherein the first monomer is 1-chloro-1,2,2-trifluoroethylene.

### Embodiment 15

A cable according to embodiment 2, wherein the first monomer is 1,1 dichloro 2,2, difluoroethylene.

### Embodiment 16

A cable according to embodiment 2, wherein the first monomer is 1,2 dichloro 1,2, difluoroethylene.

### Embodiment 17

A cable according to embodiment 2, wherein the first monomer is 1,1,2-trichloro-2-fluoroethylene.

### Embodiment 18

A cable according to embodiment 2, wherein the first monomer is hexafluoropropylene.

### Embodiment 19

A cable according to any one of embodiments 2 to 18, wherein the second monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

### Embodiment 20

A cable according to any one of embodiments 2 to 19, wherein the second monomer is ethylene.

### Embodiment 21

A cable according to any one of embodiments 2 to 19, wherein the second monomer is propylene.

### Embodiment 22

A cable according to any one of embodiments 2 to 19, wherein the second monomer is 1,1,2,2-tetrafluoroethylene.

### Embodiment 23

A cable according to any one of embodiments 2 to 19, wherein the second monomer is 1-fluoroethylene.

### Embodiment 24

A cable according to any one of embodiments 2 to 19, wherein the second monomer is 1,1-difluoroethylene.

### Embodiment 25

A cable according to any one of embodiments 2 to 19, wherein the second monomer is 1,2-difluoroethylene.

### Embodiment 26

A cable according to any one of embodiments 2 to 19, wherein the second monomer is 1,1,2-trifluoroethylene.

### Embodiment 27

A cable according to any one of embodiments 2 to 19, wherein the second monomer is hexafluoropropylene.

### Embodiment 28

A cable according to any one of embodiments 2 to 19, wherein the second monomer is perfluoropropyl vinyl ether.

### Embodiment 29

A cable according to any one of embodiments 2 to 19, wherein the second monomer is perfluoroethyl vinyl ether.

### Embodiment 30

A cable according to any one of embodiments 2 to 19, wherein the second monomer is perfluoromethyl vinyl ether.

### Embodiment 31

A cable according to any one of embodiments 2 to 19, wherein the second monomer is perfluorobutyl ether.

### Embodiment 32

A cable according to any one of embodiments 2 to 19, wherein the second monomer is 1-chloro-1,2,2-trifluoroethylene.

### Embodiment 33

A cable according to any one of embodiments 2 to 19, wherein the second monomer is 1,1 dichloro 2,2, difluoroethylene.

### Embodiment 34

A cable according to any one of embodiments 2 to 19, wherein the second monomer is 1,2 dichloro 1,2, difluoroethylene.

### Embodiment 35

A cable according to any one of embodiments 2 to 19, wherein the second monomer is 1,1,2-trichloro-2-fluoroethylene.

### Embodiment 36

A cable according to any one of embodiments 2 to 19, wherein the second monomer is hexafluoropropylene.

### Embodiment 37

A cable according to embodiment 1 or 2, wherein the first fluoropolymer is polytetrafluoroethylene.

### Embodiment 38

A cable according to embodiment 1 or 2, wherein the first fluoropolymer is poly(ethylene-co-tetrafluoroethylene).

### Embodiment 39

A cable according to any preceding embodiment, further comprising a second conductor, wherein the second conductor extends along the longitudinal axis of the cable and is axially external to the first insulator.

### Embodiment 40

A cable according to embodiment 39, further comprising a second insulator layer comprising a second fluoropolymer, wherein the second insulator layer extends along the longitudinal axis of the cable and is axially external to the second conductor.

### Embodiment 41

A cable according to embodiment 40, wherein the second fluoropolymer is a copolymer comprising a third monomer and a fourth monomer.

### Embodiment 42

A cable according to embodiment 41, wherein the third monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

### Embodiment 43

A cable according to embodiment 41, wherein the third monomer is 1,1,2,2-tetrafluoroethylene.

### Embodiment 44

A cable according to embodiment 41, wherein the third monomer is 1-fluoroethylene.

### Embodiment 45

A cable according to embodiment 41, wherein the third monomer is 1,1-difluoroethylene.

### Embodiment 46

A cable according to embodiment 41, wherein the third monomer is 1,2-difluoroethylene.

### Embodiment 47

A cable according to embodiment 41, wherein the third monomer is 1,1,2-trifluoroethylene.

### Embodiment 48

A cable according to embodiment 41, wherein the third monomer is hexafluoropropene.

### Embodiment 49

A cable according to embodiment 41, wherein the third monomer is perfluoropropyl vinyl ether.

### Embodiment 50

A cable according to embodiment 41, wherein the third monomer is perfluoroethyl vinyl ether.

### Embodiment 51

A cable according to embodiment 41, wherein the third monomer is perfluoromethyl vinyl ether.

### Embodiment 52

A cable according to embodiment 41, wherein the third monomer is perfluorobutyl ether.

### Embodiment 53

A cable according to embodiment 41, wherein the third monomer is 1-chloro-1,2,2-trifluoroethylene.

### Embodiment 54

A cable according to embodiment 41, wherein the third monomer is 1,1 dichloro 2,2, difluoroethylene.

### Embodiment 55

A cable according to embodiment 41, wherein the third monomer is 1,2 dichloro 1,2, difluoroethylene.

### Embodiment 56

A cable according to embodiment 41, wherein the third monomer is 1,1,2-trichloro-2-fluoroethylene.

### Embodiment 57

A cable according to embodiment 41, wherein the third monomer is hexafluoropropylene.

### Embodiment 58

A cable according to any one of embodiments 41 to 57, wherein the fourth monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

### Embodiment 59

A cable according to any one of embodiments 41 to 57, wherein the fourth monomer is ethylene.

### Embodiment 60

A cable according to any one of embodiments 41 to 57, wherein the fourth monomer is propylene.

### Embodiment 61

A cable according to any one of embodiments 41 to 57, wherein the fourth monomer is 1,1,2,2-tetrafluoroethylene.

### Embodiment 62

A cable according to any one of embodiments 41 to 57, wherein the fourth monomer is 1-fluoroethylene.

### Embodiment 63

A cable according to any one of embodiments 41 to 57, wherein the fourth monomer is 1,1-difluoroethylene.

### Embodiment 64

A cable according to any one of embodiments 41 to 57, wherein the fourth monomer is 1,2-difluoroethylene.

### Embodiment 65

A cable according to any one of embodiments 41 to 57, wherein the fourth monomer is 1,1,2-trifluoroethylene.

### Embodiment 66

A cable according to any one of embodiments 41 to 57, wherein the fourth monomer is hexafluoropropylene.

### Embodiment 67

A cable according to any one of embodiments 41 to 57, wherein the fourth monomer is perfluoropropyl vinyl ether.

### Embodiment 68

A cable according to any one of embodiments 41 to 57, wherein the fourth monomer is perfluoroethyl vinyl ether.

### Embodiment 69

A cable according to any one of embodiments 41 to 57, wherein the fourth monomer is perfluoromethyl vinyl ether.

### Embodiment 70

A cable according to any one of embodiments 41 to 57, wherein the fourth monomer is perfluorobutyl ether.

### Embodiment 71

A cable according to any one of embodiments 41 to 57, wherein the fourth monomer is 1-chloro-1,2,2-trifluoroethylene.

### Embodiment 72

A cable according to any one of embodiments 41 to 57, wherein the fourth monomer is 1,1 dichloro 2,2, difluoroethylene.

### Embodiment 73

A cable according to any one of embodiments 41 to 57, wherein the fourth monomer is 1,2 dichloro 1,2, difluoroethylene.

### Embodiment 74

A cable according to any one of embodiments 41 to 57, wherein the fourth monomer is 1,1,2-trichloro-2-fluoroethylene.

### Embodiment 75

A cable according to any one of embodiments 41 to 57, wherein the fourth monomer is hexafluoropropylene.

### Embodiment 76

A cable according to embodiment 40 or 41, wherein the second fluoropolymer is polytetrafluoroethylene.

### Embodiment 77

A cable according to embodiment 40 or 41, wherein the second fluoropolymer is poly(ethylene-co-tetrafluoroethylene).

### Embodiment 78

A cable according to any one of embodiments 40 to 77, further comprising a barrier layer comprising a third fluoropolymer, wherein the barrier layer extends along the longitudinal axis of the cable and is axially external to the first and second insulator layer.

### Embodiment 79

A cable according to embodiment 78, wherein the third fluoropolymer is a copolymer comprising a fifth monomer and a sixth monomer.

### Embodiment 80

A cable according to embodiment 79, wherein the fifth monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

### Embodiment 81

A cable according to embodiment 79, wherein the fifth monomer is 1,1,2,2-tetrafluoroethylene.

### Embodiment 82

A cable according to embodiment 79, wherein the fifth monomer is 1-fluoroethylene.

### Embodiment 83

A cable according to embodiment 79, wherein the fifth monomer is 1,1-difluoroethylene.

### Embodiment 84

A cable according to embodiment 79, wherein the fifth monomer is 1,2-difluoroethylene.

### Embodiment 85

A cable according to embodiment 79, wherein the fifth monomer is 1,1,2-trifluoroethylene.

### Embodiment 86

A cable according to embodiment 79, wherein the fifth monomer is hexafluoropropene.

### Embodiment 87

A cable according to embodiment 79, wherein the fifth monomer is perfluoropropyl vinyl ether.

### Embodiment 88

A cable according to embodiment 79, wherein the fifth monomer is perfluoroethyl vinyl ether.

### Embodiment 89

A cable according to embodiment 79, wherein the fifth monomer is perfluoromethyl vinyl ether.

### Embodiment 90

A cable according to embodiment 79, wherein the fifth monomer is perfluorobutyl ether.

### Embodiment 91

A cable according to embodiment 79, wherein the fifth monomer is 1-chloro-1,2,2-trifluoroethylene.

### Embodiment 92

A cable according to embodiment 79, wherein the fifth monomer is 1,1 dichloro 2,2, difluoroethylene.

### Embodiment 93

A cable according to embodiment 79, wherein the fifth monomer is 1,2 dichloro 1,2, difluoroethylene.

### Embodiment 94

A cable according to embodiment 79, wherein the fifth monomer is 1,1,2-trichloro-2-fluoroethylene.

### Embodiment 95

A cable according to embodiment 79, wherein the fifth monomer is hexafluoropropylene.

### Embodiment 96

A cable according to any one of embodiments 79 to 95, wherein the sixth monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

### Embodiment 97

A cable according to any one of embodiments 79 to 95, wherein the sixth monomer is ethylene.

### Embodiment 98

A cable according to any one of embodiments 79 to 95, wherein the sixth monomer is propylene.

### Embodiment 99

A cable according to any one of embodiments 79 to 95, wherein the sixth monomer is 1,1,2,2-tetrafluoroethylene.

### Embodiment 100

A cable according to any one of embodiments 79 to 95, wherein the sixth monomer is 1-fluoroethylene.

### Embodiment 101

A cable according to any one of embodiments 79 to 95, wherein the sixth monomer is 1,1-difluoroethylene.

### Embodiment 102

A cable according to any one of embodiments 79 to 95, wherein the sixth monomer is 1,2-difluoroethylene.

### Embodiment 103

A cable according to any one of embodiments 79 to 95, wherein the sixth monomer is 1,1,2-trifluoroethylene.

### Embodiment 104

A cable according to any one of embodiments 79 to 95, wherein the sixth monomer is hexafluoropropylene.

### Embodiment 105

A cable according to any one of embodiments 79 to 95, wherein the sixth monomer is perfluoropropyl vinyl ether.

### Embodiment 106

A cable according to any one of embodiments 79 to 95, wherein the sixth monomer is perfluoroethyl vinyl ether.

### Embodiment 107

A cable according to any one of embodiments 79 to 95, wherein the sixth monomer is perfluoromethyl vinyl ether.

### Embodiment 108

A cable according to any one of embodiments 79 to 95, wherein the sixth monomer is perfluorobutyl ether.

### Embodiment 109

A cable according to any one of embodiments 79 to 95, wherein the sixth monomer is 1-chloro-1,2,2-trifluoroethylene.

### Embodiment 110

A cable according to any one of embodiments 79 to 95, wherein the sixth monomer is 1,1 dichloro 2,2, difluoroethylene.

### Embodiment 111

A cable according to any one of embodiments 79 to 95, wherein the sixth monomer is 1,2 dichloro 1,2, difluoroethylene.

### Embodiment 112

A cable according to any one of embodiments 79 to 95, wherein the sixth monomer is 1,1,2-trichloro-2-fluoroethylene.

### Embodiment 113

A cable according to any one of embodiments 79 to 95, wherein the sixth monomer is hexafluoropropylene.

### Embodiment 114

A cable according to embodiment 78 or 79, wherein the third fluoropolymer is polytetrafluoroethylene.

### Embodiment 115

A cable according to embodiment 78 or 79, wherein the third fluoropolymer is poly(ethylene-co-tetrafluoroethylene).

### Embodiment 116

A cable according to any of embodiments 40 to 115, further comprising a jacket layer comprising a fourth fluoropolymer, wherein the jacket layer extends along the longitudinal axis of the cable and is axially external to the second insulator layer, or external to the barrier layer, if present.

### Embodiment 117

A cable according to embodiment 116, wherein the fourth fluoropolymer is a copolymer comprising a seventh monomer and an eighth monomer.

### Embodiment 118

A cable according to embodiment 117, wherein the seventh monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

### Embodiment 119

A cable according to embodiment 117, wherein the seventh monomer is 1,1,2,2-tetrafluoroethylene.

### Embodiment 120

A cable according to embodiment 117, wherein the seventh monomer is 1-fluoroethylene.

### Embodiment 121

A cable according to embodiment 117, wherein the seventh monomer is 1,1-difluoroethylene.

### Embodiment 122

A cable according to embodiment 117, wherein the seventh monomer is 1,2-difluoroethylene.

### Embodiment 123

A cable according to embodiment 117, wherein the seventh monomer is 1,1,2-trifluoroethylene.

### Embodiment 124

A cable according to embodiment 117, wherein the seventh monomer is hexafluoropropene.

### Embodiment 125

A cable according to embodiment 117, wherein the seventh monomer is perfluoropropyl vinyl ether.

### Embodiment 126

A cable according to embodiment 117, wherein the seventh monomer is perfluoroethyl vinyl ether.

### Embodiment 127

A cable according to embodiment 117, wherein the seventh monomer is perfluoromethyl vinyl ether.

### Embodiment 128

A cable according to embodiment 117, wherein the seventh monomer is perfluorobutyl ether.

### Embodiment 129

A cable according to embodiment 117, wherein the seventh monomer is 1-chloro-1,2,2-trifluoroethylene.

### Embodiment 130

A cable according to embodiment 117, wherein the seventh monomer is 1,1 dichloro 2,2, difluoroethylene.

### Embodiment 131

A cable according to embodiment 117, wherein the seventh monomer is 1,2 dichloro 1,2, difluoroethylene.

### Embodiment 132

A cable according to embodiment 117, wherein the seventh monomer is 1,1,2-trichloro-2-fluoroethylene.

### Embodiment 133

A cable according to embodiment 117, wherein the seventh monomer is hexafluoropropylene.

### Embodiment 134

A cable according to any one of embodiments 117 to 133, wherein the eighth monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

### Embodiment 135

A cable according to any one of embodiments 117 to 133, wherein the eighth monomer is ethylene.

### Embodiment 136

A cable according to any one of embodiments 117 to 133, wherein the eighth monomer is propylene.

### Embodiment 137

A cable according to any one of embodiments 117 to 133, wherein the eighth monomer is 1,1,2,2-tetrafluoroethylene.

### Embodiment 138

A cable according to any one of embodiments 117 to 133, wherein the eighth monomer is 1-fluoroethylene.

### Embodiment 139

A cable according to any one of embodiments 117 to 133, wherein the eighth monomer is 1,1-difluoroethylene.

### Embodiment 140

A cable according to any one of embodiments 117 to 133, wherein the eighth monomer is 1,2-difluoroethylene.

### Embodiment 141

A cable according to any one of embodiments 117 to 133, wherein the eighth monomer is 1,1,2-trifluoroethylene.

### Embodiment 142

A cable according to any one of embodiments 117 to 133, wherein the eighth monomer is hexafluoropropylene.

### Embodiment 143

A cable according to any one of embodiments 117 to 133, wherein the eighth monomer is perfluoropropyl vinyl ether.

### Embodiment 144

A cable according to any one of embodiments 117 to 133, wherein the eighth monomer is perfluoroethyl vinyl ether.

### Embodiment 145

A cable according to any one of embodiments 117 to 133, wherein the eighth monomer is perfluoromethyl vinyl ether.

### Embodiment 146

A cable according to any one of embodiments 117 to 133, wherein the eighth monomer is perfluorobutyl ether.

### Embodiment 147

A cable according to any one of embodiments 117 to 133, wherein the eighth monomer is 1-chloro-1,2,2-trifluoroethylene.

### Embodiment 148

A cable according to any one of embodiments 117 to 133, wherein the eighth monomer is 1,1 dichloro 2,2, difluoroethylene.

### Embodiment 149

A cable according to any one of embodiments 117 to 133, wherein the eighth monomer is Embodiment 1,2 dichloro 1,2, difluoroethylene.

### Embodiment 150

A cable according to any one of embodiments 117 to 133, wherein the eighth monomer is 1,1,2-trichloro-2-fluoroethylene.

### Embodiment 151

A cable according to any one of embodiments 117 to 133, wherein the eighth monomer is hexafluoropropylene.

### Embodiment 152

A cable according to embodiment 116 or 117, wherein the fourth fluoropolymer is polytetrafluoroethylene.

### Embodiment 153

A cable according to embodiment 116 or 117, wherein the fourth fluoropolymer is poly(ethylene-co-tetrafluoroethylene).

### Embodiment 154

A cable according to any one of embodiments 116 to 153, further comprising a first plurality of wires, wherein the first plurality of wires extends along the longitudinal axis of the cable and is axially external to the jacket layer. The first plurality of wires is axially external to the first insulator layer. The first plurality of wires may be axially external to the second conductor, if present. The first plurality of wires may be axially external to the second insulator layer, if present. The first plurality of wires may be axially external to the barrier layer, if present. The first plurality of wires may be axially external to the jacket layer, if present.

### Embodiment 155

A cable according to embodiment 154, further comprising a second plurality of wires, wherein the second plurality of wires extends along the longitudinal axis of the cable and is axially external to the first plurality of wires.

### Embodiment 156

A cable according to embodiment 155 wherein the wires of the first plurality of wires are helically wound in a first direction, and the wires of the second plurality of wires are helically wound in a direction opposite to the first direction.

### Embodiment 157

A cable according to any preceding embodiment, wherein the first conductor comprises copper or copper alloy.

### Embodiment 158

A cable according to any one of embodiments 39 to 157, wherein the second conductor comprises copper or copper alloy.

### Embodiment 159

A cable according to any preceding embodiment, wherein the first conductor comprises a plurality of stranded wires.

### Embodiment 160

A cable according to any one of embodiments 39 to 159, wherein the second conductor comprises a plurality of stranded wires.

### Embodiment 161

A cable according to embodiment 159 or 160, wherein the plurality of the stranded wires of the first conductor are braided.

### Embodiment 162

A cable according to embodiment 160 or 161, wherein the plurality of the stranded wires of the second conductor are braided.

### Embodiment 163

A cable according to any of embodiments 154 to 162, wherein the first plurality of wires and/or the second plurality of wires comprises an alloy comprising nickel.

### Embodiment 164

A cable according to any of embodiments 154 to 162, wherein the first plurality of wires and/or the second plurality of wires comprises an alloy consists of nickel, chromium and optionally up to 20% (w/w) additives or impurities.

### Embodiment 165

A cable according to embodiment 164 wherein the alloy consists of from 40 to 74% (w/w) nickel, 14 to 25% (w/w) chromium, and optionally up to 20% (w/w) additives or impurities.

### Embodiment 166

A cable according to embodiment 164 or 165 wherein the additives or impurities are selected from iron, molybdenum, niobium, cobalt, manganese, copper, aluminium, titanium, silicon, carbon, sulphur, phosphorus or boron, or any combination thereof,

### Embodiment 167

A cable according to any of embodiments 163 to 166 wherein the alloy consists of 58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives.

### Embodiment 168

A use of a fluoropolymer as an insulator in an armoured cable.

### Embodiment 169

A use according to embodiment 168, wherein the cable is used downhole.

### Embodiment 170

A use according to embodiment 168 or 169, wherein the cable is subjected to temperatures greater than 100° C., preferably 110° C., more preferably 120°.

### Embodiment 171

A use according to embodiment 168, 169 or 170, wherein the fluoropolymer is a copolymer comprising a first monomer and a second monomer.

### Embodiment 172

A use according to embodiment 171, wherein the first monomer is selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene.

### Embodiment 173

A use according to embodiment 171, wherein the first monomer is 1,1,2,2-tetrafluoroethylene.

### Embodiment 174

A use according to embodiment 171, wherein the first monomer is 1-fluoroethylene.

### Embodiment 175

A use according to embodiment 171, wherein the first monomer is 1,1-difluoroethylene.

### Embodiment 176

A use according to embodiment 171, wherein the first monomer is 1,2-difluoroethylene.

### Embodiment 177

A use according to embodiment 171, wherein the first monomer is 1,1,2-trifluoroethylene.

### Embodiment 178

A use according to embodiment 171, wherein the first monomer is hexafluoropropene.

### Embodiment 179

A use according to embodiment 171, wherein the first monomer is perfluoropropyl vinyl ether.

### Embodiment 180

A use according to embodiment 171, wherein the first monomer is perfluoroethyl vinyl ether.

### Embodiment 181

A use according to embodiment 171, wherein the first monomer is perfluoromethyl vinyl ether.

### Embodiment 182

A use according to embodiment 171, wherein the first monomer is perfluorobutyl ether.

### Embodiment 183

A use according to embodiment 171, wherein the first monomer is 1-chloro-1,2,2-trifluoroethylene.

### Embodiment 184

A use according to embodiment 171, wherein the first monomer is 1,1 dichloro 2,2, difluoroethylene.

### Embodiment 185

A use according to embodiment 171, wherein the first monomer is 1,2 dichloro 1,2, difluoroethylene.

### Embodiment 186

A use according to embodiment 171, wherein the first monomer is 1,1,2-trichloro-2-fluoroethylene.

### Embodiment 187

A use according to embodiment 171, wherein the first monomer is hexafluoropropylene.

### Embodiment 188

A use according to any one of embodiments 171 to 187, wherein the second monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene.

### Embodiment 189

A use according to any one of embodiments 171 to 187, wherein the second monomer is ethylene.

### Embodiment 190

A use according to any one of embodiments 171 to 187, wherein the second monomer is propylene.

### Embodiment 191

A use according to any one of embodiments 171 to 187, wherein the second monomer is 1,1,2,2-tetrafluoroethylene.

### Embodiment 192

A use according to any one of embodiments 171 to 187, wherein the second monomer is 1-fluoroethylene.

### Embodiment 193

A use according to any one of embodiments 171 to 187, wherein the second monomer is 1,1-difluoroethylene.

### Embodiment 194

A use according to any one of embodiments 171 to 187, wherein the second monomer is 1,2-difluoroethylene.

### Embodiment 195

A use according to any one of embodiments 171 to 187, wherein the second monomer is 1,1,2-trifluoroethylene.

### Embodiment 196

A use according to any one of embodiments 171 to 187, wherein the second monomer is hexafluoropropylene.

### Embodiment 197

A use according to any one of embodiments 171 to 187, wherein the second monomer is perfluoropropyl vinyl ether.

### Embodiment 198

A use according to any one of embodiments 171 to 187, wherein the second monomer is perfluoroethyl vinyl ether.

### Embodiment 199

A use according to any one of embodiments 171 to 187, wherein the second monomer is perfluoromethyl vinyl ether.

### Embodiment 200

A use according to any one of embodiments 171 to 182, wherein the second monomer is perfluorobutyl ether.

### Embodiment 201

A use according to any one of embodiments 171 to 187, wherein the second monomer is 1-chloro-1,2,2-trifluoroethylene.

### Embodiment 202

A use according to any one of embodiments 171 to 187, wherein the second monomer is 1,1 dichloro 2,2, difluoroethylene.

### Embodiment 203

A use according to any one of embodiments 171 to 187, wherein the second monomer is 1,2 dichloro 1,2, difluoroethylene.

### Embodiment 204

A use according to any one of embodiments 171 to 187, wherein the second monomer is 1,1,2-trichloro-2-fluoroethylene.

### Embodiment 205

A use according to any one of embodiments 171 to 187, wherein the second monomer is hexafluoropropylene.

### Embodiment 206

A use according to any one of embodiments 168 to 171, wherein the fluoropolymer is polytetrafluoroethylene.

### Embodiment 207

A use according to any one of embodiments 168 to 171, wherein the fluoropolymer is poly(ethylene-co-tetrafluoroethylene).

### Embodiment 208

A method of manufacturing a cable according to any one of embodiments 1 to 167, comprising disposing the first insulator layer around the first conductor and along a longitudinal axis thereof, and disposing the first plurality of wires around the first insulator layer and along a longitudinal axis thereof, wherein the first insulator layer comprises the first fluoropolymer.

### Embodiment 209

A method according to embodiment 208, comprising providing the second conductor, and disposing the second conductor along the longitudinal axis and external to the first insulator layer.

### Embodiment 210

A method according to embodiment 209, comprising providing a second insulator layer, and disposing the second insulator layer along the longitudinal axis and around the second conductor.

### Embodiment 211

A method according to embodiment 210, comprising providing a barrier layer, and disposing the barrier layer around the first and second insulating layers.

### Embodiment 212

A method according to embodiment 211, comprising providing a jacket layer, and disposing the jacket layer around the barrier layer.

### Embodiment 213

A method of transmitting electricity, comprising providing a first installation or device and a second installation or device connected by a cable according to any one of embodiments 1 to 167, and transmitting electricity from the first installation or device to the second installation or device through the cable, wherein the first installation or device is in a wellbore.

### Embodiment 214

A method according to embodiment 213, wherein the first installation or device is a sensor.

### Embodiment 215

A method according to embodiment 213, wherein the first installation or device is an electrical submersible pump.

### Embodiment 216

A method according to any of embodiments 213 to 215, wherein the second installation or device is a winch, reel or spool.

### Embodiment 217

A method according to any of embodiments 213 to 216, wherein the first device or installation is lowered into the wellbore by lowering a tension applied to the cable.

### Embodiment 218

A method according to any of embodiments 213 to 217, wherein the first device or installation is raised from the wellbore by increasing a tension to the cable.

### Embodiment 219

A method of suspending a first device or installation in a wellbore, comprising providing a cable according to any one of embodiments 1 to 167, securing a first end of the cable to the first device or installation, securing a second end of the cable to a second device or installation, and suspending the first device or installation in the wellbore.

### Embodiment 220

A method according to embodiment 219 wherein the first installation or device is a sensor.

### Embodiment 221

A method according to embodiment 220 wherein the first installation or device is an electrical submersible pump.

### Embodiment 222

A method according to any of embodiments 219 to 221, wherein the second installation or device is a winch, reel or spool.

### Embodiment 223

A method according to any of embodiments 219 to 222 wherein the second installation or device is located at the surface.

### Embodiment 224

A method according to any of embodiments 219 to 223, wherein the first device or installation is lowered into the wellbore by lowering a tension applied to the cable.

### Embodiment 225

A method according to any of embodiments 219 to 223, wherein the first device or installation is raised from the wellbore by increasing a tension to the cable.

### Embodiment 226

A method according to any of embodiments 219 to 225, further comprising transmitting electricity from the first installation or device to the second installation or device through the cable.

### Embodiment 227

A cable substantially as herein described, with reference to the drawings.

### Embodiment 228

A method of manufacturing a cable substantially as herein described, with reference to the drawings.

1. A cable comprising a first conductor, and a first insulator layer and a first plurality of wires,
wherein the first conductor, the first insulator and the first plurality of wires extend along an longitudinal axis of the cable,
wherein the first insulator layer is axially external to the conductor and the first plurality of wires is axially external to the first insulator, and
wherein the first insulator layer comprises a first fluoropolymer.

2. The cable of claim 1, wherein the first fluoropolymer is a copolymer comprising:
a first monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
a second monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
preferably wherein the first fluoropolymer is polytetrafluoroethylene or poly(ethylene-co-tetrafluoroethylene).

3. The cable of claim 1, further comprising a second conductor, wherein the second conductor extends along the longitudinal axis of the cable and is axially external to the first insulator.

4. The cable of claim 3, further comprising a second insulator layer comprising a second fluoropolymer, wherein the second insulator layer extends along the longitudinal axis of the cable and is axially external to the second conductor.

5. The cable of claim 4, wherein the second fluoropolymer is a copolymer comprising:
a third monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
a fourth monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
preferably wherein the second fluoropolymer is polytetrafluoroethylene or poly(ethylene-co-tetrafluoroethylene).

6. The cable of claim 4, further comprising a barrier layer comprising a third fluoropolymer, wherein the barrier layer extends along the longitudinal axis of the cable and is axially external to the first and second insulator layer.

7. The cable of claim 6, wherein the third fluoropolymer is a copolymer comprising:
a fifth monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and a sixth monomer is selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
preferably wherein the third fluoropolymer is polytetrafluoroethylene or poly(ethylene-co-tetrafluoroethylene).

8. The cable of claim 6, further comprising a jacket layer comprising a fourth fluoropolymer, wherein the jacket layer extends along the longitudinal axis of the cable and is axially external to the barrier layer.

9. The cable of claim 8, wherein the fourth fluoropolymer is a copolymer comprising:
a seventh monomer selected from a group consisting of 1,1,2,2-tetrafluoroethylene, 1-fluoroethylene, 1,1-difluoroethylene, 1,2-difluoroethylene, 1,1,2-trifluoroethylene, hexafluoropropene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene, and hexafluoropropylene, and
an eighth monomer selected from a group consisting of ethylene, propylene, 1,1,2,2-tetrafluoroethylene, 1-fluoroethylene, 1,1-difluoroethylene, 1,2-difluoroethylene, 1,1,2-trifluoroethylene, hexafluoropropylene, perfluoropropyl vinyl ether, perfluoroethyl vinyl ether, perfluoromethyl vinyl ether, perfluorobutyl ether, 1-chloro-1,2,2-trifluoroethylene, 1,1 dichloro 2,2, difluoroethylene, 1,2 dichloro 1,2, difluoroethylene, 1,1,2-trichloro-2-fluoroethylene and hexafluoropropylene,
preferably wherein the fourth fluoropolymer is polytetrafluoroethylene or poly(ethylene-co-tetrafluoroethylene).

10. The cable of claim 1, further comprising a second plurality of wires, wherein the second plurality of wires extends along the longitudinal axis of the cable and is axially external to the first plurality of wires.

11. The cable of claim 10, wherein the wires of the first plurality of wires are helically wound in a first direction, and the wires of the second plurality of wires are helically wound in a direction opposite to the first direction.

12. The cable of claim 1, wherein the first conductor and/or the second conductor comprises copper or copper alloy.

13. The cable of claim 1, wherein the first conductor comprises a plurality of stranded wires, optionally wherein the plurality of the stranded wires of the first conductor are braided.

14. The cable of claim 1, wherein the first plurality of wires comprises an alloy comprising nickel.

15. The cable of claim 1, wherein the first plurality of wires comprises an alloy consisting of:
nickel, chromium and optionally up to 20% (w/w) additives or impurities;
40 to 74% (w/w) nickel, 14 to 25% (w/w) chromium, and optionally up to 20% (w/w) additives or impurities;
58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives;
72% (w/w) nickel, 14-17% (w/w) chromium, 6-10% (w/w) iron, 1% (w/w) manganese, 0.5% (w/w) copper, with remainder impurities or additives;
44.2%-56% (w/w) nickel, 20-24% (w/w) chromium, 3% (w/w) iron, 8-10% (w/w) molybdenum, 10-15% (w/w) cobalt, 0.5% (w/w) manganese, 0.5% (w/w) copper, 0.8-1.5% (w/w) aluminium, 0.6% (w/w) titanium with remainder impurities or additives;
58% (w/w) nickel, 20-23% (w/w) chromium, 5% (w/w) iron, 8-10% (w/w) molybdenum, 3.15-4.15% (w/w) niobium, 1% (w/w) cobalt, 0.5% (w/w) manganese, 0.4% (w/w) aluminium, 0.4% (w/w) titanium, with remainder impurities or additives;
50-55% (w/w) nickel, 17-21% (w/w) chromium, 2.8-3.3% (w/w) molybdenum, 4.75-5.5% (w/w) niobium, 1% cobalt, 0.35% (w/w) manganese, 0.2-0.8% (w/w) aluminium, 0.65-1.15% (w/w) titanium, 0.3% (w/w) copper with remainder impurities or additives; or
70% (w/w) nickel, 14-17% (w/w) chromium, 5-9% (w/w) iron, 0.7-1.2% (w/w) niobium, 1% (w/w) cobalt, 1% (w/w) manganese, 0.5% (w/w) copper, 0.4-1% (w/w) aluminium, 2.25-2.75% (w/w) titanium with remainder impurities or additives,

16. The cable of claim 15, wherein the additives or impurities are selected from iron, molybdenum, niobium, cobalt, manganese, copper, aluminium, titanium, silicon, carbon, sulphur, phosphorus or boron, or any combination thereof,

17. A method of manufacturing a cable according to claim 1, comprising:
disposing the first insulator layer around the first conductor and along a longitudinal axis thereof, and
disposing the first plurality of wires around the first insulator layer and along a longitudinal axis thereof,
wherein the first insulator layer comprises the first fluoropolymer.

18. A method of transmitting electricity, comprising providing a first installation or device and a second installation or device connected by the cable of claim 1, and transmitting electricity from the first installation or device to the second installation or device through the cable, wherein the first installation or device is in a wellbore.

19. The method of claim 18, wherein the first device or installation is lowered into the wellbore by lowering a tension applied to the cable, and/or raised from the wellbore by increasing a tension to the cable.

20. A method of suspending a first device or installation in a wellbore, comprising providing the cable of claim 1, securing a first end of the cable to the first device or installation, securing a second end of the cable to a second device or installation, and suspending the first device or installation in the wellbore.

21. The method of claim 20, further comprising transmitting electricity from the first installation or device to the second installation or device through the cable.
